(19) United States
(12) Patent Application Publication
(10) Pub. No.: US 2011/0050900 A1
(43) Pub. Date: Mar. 3, 2011

(54) IMAGE PROCESSING APPARATUS, WEARABLE IMAGE PROCESSING APPARATUS, AND METHOD OF CONTROLLING IMAGE PROCESSING APPARATUS

(75) Inventor: Yoshimi Sato, Shizuoka (JP)

(73) Assignee: TOSHIBA TEC KABUSHIKI KAISHA, Tokyo (JP)

(21) Appl. No.: 12/836,880

(22) Filed: Jul. 15, 2010

(30) Foreign Application Priority Data
Aug. 31, 2009 (JP) 2009-200827

(51) Int. Cl. H04N 7/18; G09G 5/00

(52) U.S. Cl. 348/143; 345/7; 348/E07.085

(57) ABSTRACT

According to one embodiment, an image processing apparatus includes an imaging unit, a selecting unit, a receiving unit, and a delivering unit. The imaging unit picks up a video of a cooking scene. The selecting unit selects, out of order items received from a customer, an order item to be delivered. The receiving unit receives, from a user, a delivery instruction for a video of a cooking scene related to the selected order item. The delivering unit delivers the picked-up video of the cooking scene according to the received delivery instruction.

### CROSS-REFERENCE TO RELATED APPLICATION

This application is based upon and claims the benefit of priority from Japanese Patent Application No. 2009-200827 filed on Aug. 31, 2009, the entire content of which is incorporated herein by reference.

### FIELD

Embodiments described herein relate generally to an image processing apparatus, a wearable image processing apparatus, and a method of controlling the image processing apparatus.

### BACKGROUND

In eating houses such as restaurants, in some case, a cooking scene is displayed on an advertisement terminal set on a customer table or the outdoors to attract customers. As a related art for displaying a cooking scene of an eating house, JP-A-2004-133870 is known. JP-A-2004-133870 discloses a menu providing apparatus configured to display a cooking scene or the like in a cooking process when a customer selects any one of menu items in a seat.

However, in the technique disclosed in JP-A-2004-133870, a cooking scene is simply displayed when a customer selects a menu item in a seat. A cooking scene of a chef cooking a food item selected by the chef cannot be presented to the customer.

### BRIEF DESCRIPTION OF THE DRAWINGS

FIG. 1 is a diagram of an example of an order system according to an embodiment;

FIG. 2 is a diagram of an example of a head mount display according to the embodiment;

FIG. 3 is a diagram of an example of a kitchen;

FIG. 4 is a ladder chart for explaining an example of the operation of the order system according to the embodiment;

FIG. 5 is a diagram of a display example of a monitor display unit;

FIG. 6 is a diagram of a display example of the monitor display unit;

FIG. 7 is a diagram of a display example of a display in an advertisement terminal; and

FIG. 8 is a flowchart for explaining processing by a wearable image processing apparatus according to the embodiment.

### DETAILED DESCRIPTION

In general, according to one embodiment, an image processing apparatus includes an imaging unit, a selecting unit, a receiving unit, and a delivering unit. The imaging unit picks up a video of a cooking scene. The selecting unit selects, out of order items received from a customer, an order item to be delivered. The receiving unit receives, from a user, a delivery instruction for a video of a cooking scene related to the selected order item. The delivering unit delivers the picked-up video of the cooking scene according to the received delivery instruction.

According to another embodiment, a wearable image processing apparatus includes an imaging unit, a head mount display, a selecting unit, a receiving unit, and a delivering unit. The imaging unit picks up a video of a cooking scene. The head mount display includes a monitor display unit configured to display order items included in order information received from a customer. The selecting unit selects, out of the displayed order items, an order item to be delivered. The receiving unit receives, from a wearer of the head mount display, a delivery instruction for a video of a cooking scene related to the selected order item. The delivering unit delivers the picked-up video of the cooking scene according to the received delivery instruction.

According to still another embodiment, a method of controlling an image processing apparatus including an imaging unit configured to pick up a video of a cooking scene includes selecting, out of order items received from a customer, an order item to be delivered, receiving, from a user, a delivery instruction for a video of a cooking scene related to the selected order item, and delivering the picked-up video of the cooking scene picked up according to the received delivery instruction.

An embodiment of the image processing apparatus, the wearable image processing apparatus, and the method of controlling the image processing apparatus is explained in detail below with reference to the accompanying drawings. In an example explained in this embodiment, the wearable image processing apparatus is applied to a user interface used by a chef in an order system set in a restaurant or the like.

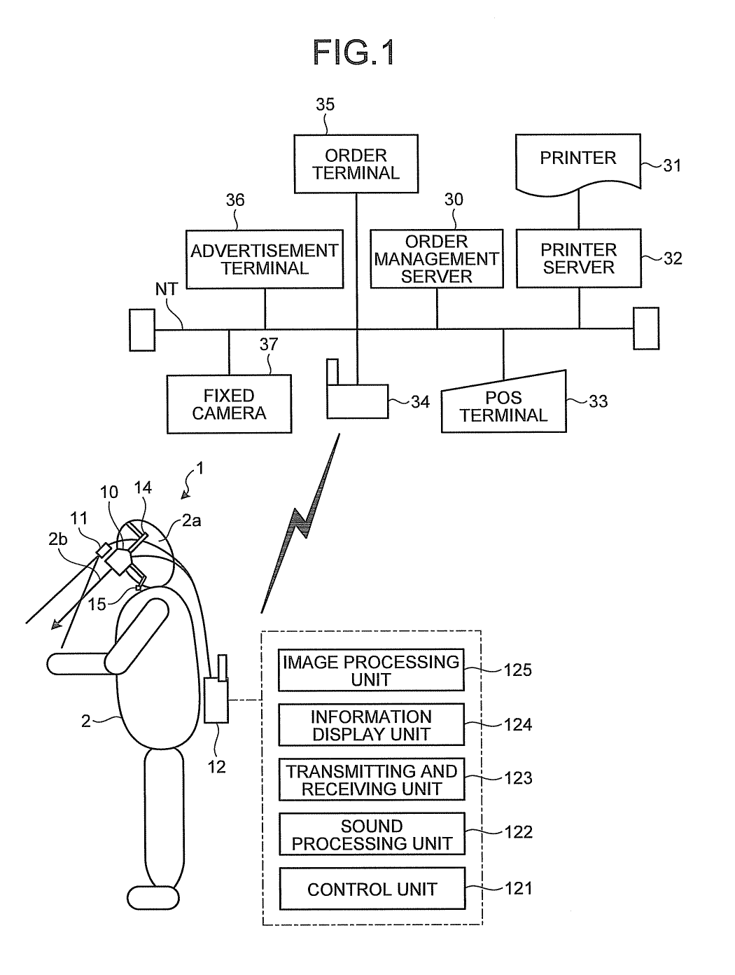

FIG. 1 is a diagram of an example of an order system according to this embodiment. As shown in FIG. 1, the order system includes a wearable image processing apparatus 1, an order management server 30, a printer server 32, a transmitting and receiving device 34, an order terminal 35, an advertisement terminal 36, and a fixed camera 37. The wearable image processing apparatus 1 is a user interface that a wearer 2 as a chef wears and uses. The order management server 30 manages an order from the order terminal 35. The printer server 32 controls a printer 31 for printing various slips (e.g., an order slip). The transmitting and receiving device 34 performs transmission and reception of data to and from the wearable image processing apparatus 1. A store clerk such as a waiter or a waitress uses the order terminal 35 in receiving an order from a customer. The advertisement terminal 36 displays an advertisement and receives an order for an advertised item. The fixed camera 37 is fixed in a predetermined position and picks up an image of an area set in advance. The wearable image processing apparatus 1, the order management server 30, the printer server 32, the transmitting and receiving device 34, the order terminal 35, the advertisement terminal 36, and the fixed camera 37 are connected to one another via a network NT. The network NT is a LAN (Local Area Network), an Intranet, an Ethernet (registered trademark), or the like.

The transmission and reception of data between the transmitting and receiving device 34 and the wearable image processing apparatus 1 may be performed by using a radio wave, light, an infrared ray, ultrasound, or the like. In this embodiment, it is assumed that the transmission and reception of data is performed by using near radio communication (e.g., Bluetooth (registered trademark)) having a communication range of about several meters. Plural transmitting and receiving devices 34 are provided to cover all areas in a restaurant (e.g., near a checkout counter, a floor of customer tables, and a backyard). The transmitting and receiving device 34 may perform transmission and reception of data with the order terminal 35. It is unnecessary to connect the order terminal 35 to the network NT by wire.

The order management server 30 manages an order for food input to the order terminal 35 by a store clerk. Specifically, the order management server 30 allocates a unique order number to order information notified from the order terminal 35, stores the order number in a storage or the like in the order management server 30, and registers order information. The order information includes a customer table from which an order is received, the number of customers, order items, the numbers of the order items, and the like. The order information registered in the order management server 30 is printed as an order slip by the printer 31 together with the order number. The order slip is passed to a customer as a slip used for checkout in a POS terminal 33, for example, after foods are provided. The order management server 30 notifies the wearable image processing apparatus 1 of the registered order information and delivers various kinds of information to the order terminal 35.

The POS terminal 33 includes a drawer, a key input unit, a scanner, a card reader, a display, a receipt and journal printer and the like (all of which are not shown in the figure). The POS terminal 33 performs a transaction using cash or a credit card. The POS terminal 33 is provided in, for example, a checkout counter. For example, the POS terminal 33 receives, through key input, scanner reading, or the like, an order number printed on an order slip and acquires order information corresponding to the order number from the order management server 30. The POS terminal 33 reads out a master file, in which an identification code and a price for each of food items (menu items) are preset, from an internal ROM (Read Only Memory) or a data server (not specifically shown) and performs settlement of an order related to the acquired order information.

The order terminal 35 is an information terminal used by a store clerk. The order terminal 35 includes a display such as a LCD (Liquid Crystal Display) and an operation input unit such as a touch panel for receiving an operation input. The order terminal 35 receives an order from a customer input through the operation input unit and displays, on a display, information delivered from the order management server 30.

The advertisement terminal 36 is information terminal set on a customer table, the outdoors, or the like and displays an advertisement and receives an order for an advertised item. The advertisement terminal 36 includes a display such as a LCD (Liquid Crystal Display) and an operation input unit such as a touch panel for receiving an operation input. For example, the advertisement terminal 36 displays a video of cooking as an advertisement and receives an order for a food item being cooked (details are explained later).

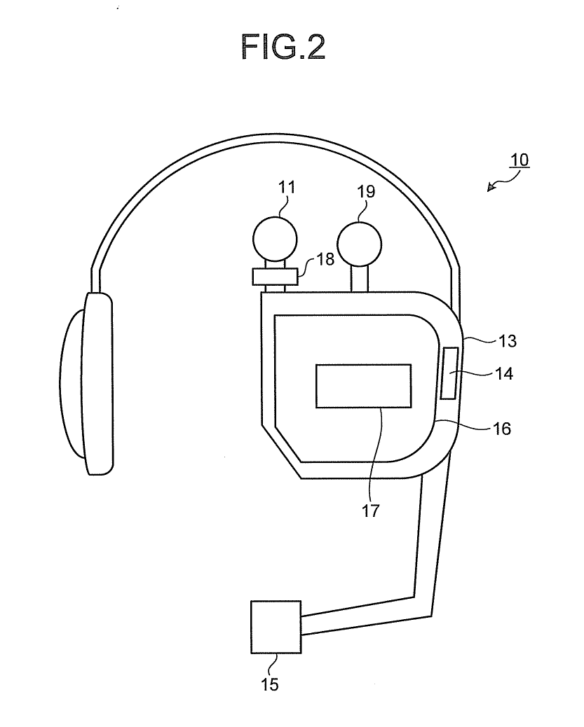

The wearable image processing apparatus 1 is an information terminal that the wearer 2 (a chef) wears and uses. The wearable image processing apparatus 1 includes a head mount display 10, a digital camera 11 as an imaging device, an interface box 12, and a microphone 15. As shown in FIG. 2, the head mount display 10 includes a frame body 13 for holding a light transmissive member 16 including a monitor display unit 17 and a mounting arm 14 of a headphone type for arranging the frame body 13 in front of the left eye of the wearer 2. Specifically, the head mount display 10 can be mounted on a head 2a of the wearer 2 by the mounting arm 14. In a mounted state, the frame body 13 is arranged in front of the left eye of the wearer 2.

The frame body 13 is formed in a shape of a size adjusted to the left eye of the wearer 2. The digital camera 11 is provided in an upper part on the outside of a frame of the frame body 13 via an imaging direction variable mechanism 18. A camera for line-of-sight recognition 19 for picking up an image of the pupil of the wearer 2 and detecting a line of sight 2b (a line of sight position) is provided on the outside of the frame of the frame body 13. The microphone 15 for collecting sound of the wearer 2 and around the wearer 2 is provided below the frame body 13. The light transmissive member 16 of a tabular shape formed to be adjusted to, for example, a shape of the frame of the frame body 13 is held in the frame. Even when the head mount display 10 is mounted on the head 2a of the wearer 2, the light transmissive member 16 allows the eyes of the wearer 2 to observe an ambient environment. The light transmissive member 16 may be, for example, colorless and transparent or have a color determined in advance.

The monitor display unit 17 is formed in a part in the light transmissive member 16. The monitor display unit 17 monitor-displays, on a real time basis, for example, image data of a moving image acquired by imaging by the digital camera 11 and various kinds of information. Therefore, monitor display on the left eye of the wearer 2 can be performed in a state in which the head mount display 10 is mounted. The monitor display unit 17 performs monitor display in a light transmissive state. Therefore, the monitor display unit 17 allows the wearer 2 to observe an ambient environment even in a state in which the monitor display is performed on a real time basis. For example, with the wearable image processing apparatus 1, even when the chef is cooking foods, the chef can check the monitor display while cooking the foods.

In the example explained in this embodiment, the frame body 13 is arranged in front of the left eye of the wearer 2 and the monitor display on the left eye of the wearer 2 is performed. However, the monitor display for the wearer 2 may be performed on the right eye or both the eyes. For example, it is possible to perform the monitor display on the right eye of the wearer 2 by arranging the frame body 13 in front of the right eye of the wearer 2.

The digital camera 11 as a first camera performs imaging operation and outputs image data of a moving image. The digital camera 11 is attached on the frame body 13 of the head mount display 10 in a state in which an imaging range is set such that a focus is adjusted to the direction of the line of sight 2b of the wearer 2 through the light transmissive member 16. For example, the imaging direction variable mechanism 18 supports the digital camera 11 to be capable of swinging. The imaging direction variable mechanism 18 sets an imaging direction of the digital camera 11 such that the focus is adjusted to an arbitrary direction, i.e., the direction of the line of sight 2b of the wearer 2 as explained above. Therefore, when the chef wearing the wearable image processing apparatus 1 is cooking foods, an image of an area where the cooking is performed can be picked up.

The interface box 12 performs transmission and reception of data to and from the transmitting and receiving device 34 and performs various kinds of processing related to the head mount display 10. Specifically, the interface box 12 includes a control unit 121, a sound processing unit 122, a transmitting and receiving unit 123, an information display unit 124, and an image processing unit 125. The interface box 12 is a box that the wearer 2 can carry. The control unit 121 is a computer including a CPU (Central Processing Unit), a RAM (Random Access Memory), a ROM and the like. The control unit 121 controls the operation of the wearable image processing apparatus 1. A program, various kinds of setting information referred to when the program is executed, and the like are stored in the ROM in advance. The CPU expands the program stored in the ROM on a work area of the RAM and sequentially executes the program to centrally control the operation of the wearable image processing apparatus 1. Functions of the units such as the image processing unit 125, the information display unit 124, the transmitting and receiving unit 123, and the sound processing unit 122 in the interface box 12 may be realized by the control unit 121 executing the program stored in the ROM in advance.

The sound processing unit 122 performs processing such as recognition of sound input from the microphone 15. Specifically, the sound processing unit 122 collates sound data included in dictionary data set in advance and sound data from the microphone 15 and recognizes a predetermined sound command. The sound processing unit 122 notifies the control unit 121 of the recognized sound command. The control unit 121 performs processing corresponding to the notified sound command. Consequently, the wearable image processing apparatus 1 can be operated by a sound command uttered by the wearer 2. The operation of the wearable image processing apparatus 1 by the sound command is hereinafter referred to as sound operation. The wearable image processing apparatus 1 receives sound operation by the wearer 2. Therefore, labor and time of manual input by the wearer 2 can be omitted. In particular, this sound operation is effective when the wearer 2 is cooking foods.

The information display unit 124 displays, on the monitor display unit 17 of the head mount display 10, image data input from the control unit 121 or the like. The information display unit 124 displays, under the control by the control unit 121, various images of an information window, an icon, and the like at a predetermined coordinate of the monitor display unit 17.

The image processing unit 125 performs image processing for image data acquired by the imaging by the digital camera 11 and analyzes image data picked up by the camera for line-of-sight recognition 19 to detect the line of sight 2b of the wearer 2. Specifically, the image processing unit 125 detects the pupil of the wearer 2 from the image data picked up by the camera for line-of-sight recognition 19. Subsequently, the image processing unit 125 detects the line of sight 2b according to the position of the detected pupil. A detection result of the line of sight 2b is output to the information display unit 124. The information display unit 124 displays an order display window at a coordinate of the monitor display unit 17 corresponding to the detection result of the line of sight 2b output from the image processing unit 125.

The input operation in the wearable image processing apparatus 1 may be performed under the control by the control unit 121 on the basis of an image of the camera for line-of-sight recognition 19 according to the line of sight 2b detected by the image processing unit 125. Specifically, the input operation in the wearable image processing apparatus 1 is performed by detecting the line of sight 2b of the wearer 2 looking at an icon image for operation input displayed on the monitor display unit 17 by the information display unit 124. For example, when an icon image displayed at a predetermined coordinate of the monitor display unit 17 and an order display window by a detection result of the line of sight 2b overlap, input operation corresponding to the icon image is received. The input operation in the wearable image processing apparatus 1 corresponding to the line of sight 2b is hereinafter referred to as line-of-sight operation. The wearable image processing apparatus 1 receives the line-of-sight operation by the wearer 2. Therefore, labor and time of manual input by the wearer 2 can be omitted. In particular, this line-of-sight operation is effective when the wearer 2 is cooking foods.

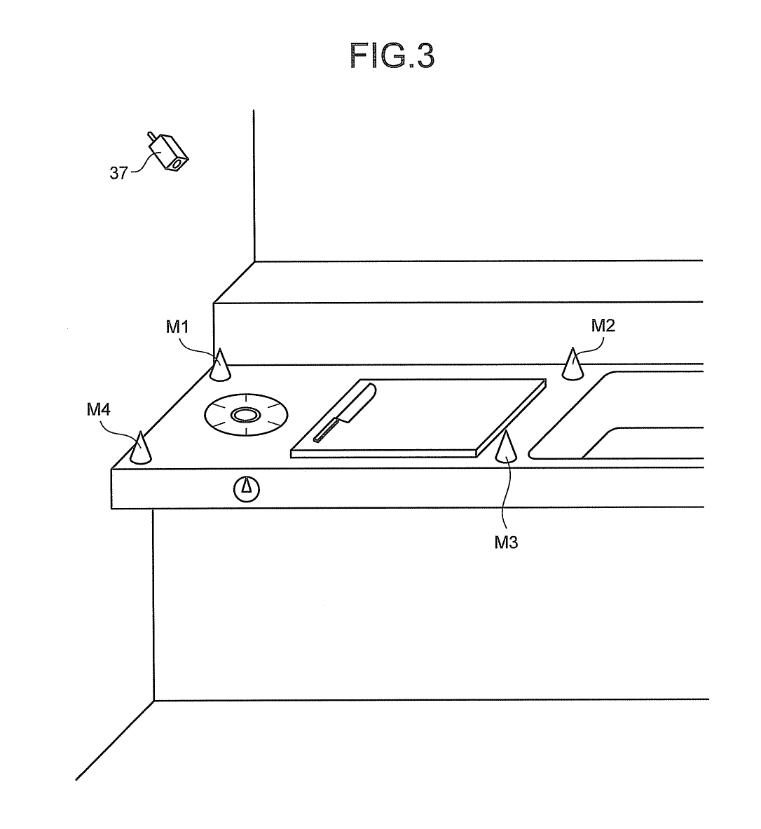

The fixed camera 37 as a second camera is a digital camera fixed in the kitchen. The fixed camera 37 picks up an image of an area where the chef actually performs cooking in the kitchen (hereinafter referred to as cooking area). FIG. 3 is a diagram of an example of the kitchen. As shown in FIG. 3, the fixed camera 37 is fixedly provided on a wall or the like of the kitchen and picks up images of a gas range, a kitchen table, and the like in the cooking area while panning a focus. Therefore, an imaging range of the fixed camera 37 is the entire cooking area and a video picked up by the fixed camera 37 is a video of the entire cooking area. The video picked up by the fixed camera 37 is delivered to the advertisement terminal 36 according to an instruction of the wearable image processing apparatus 1.

Identification markers M1 to M4 are markers for identifying the cooking area and arranged in advance to correspond to the cooking area. For example, the identification marker M1 is arranged at the upper left corner of the cooking area. The identification marker M2 is arranged at the upper right corner of the cooking area. The identification marker M3 is arranged at the lower right corner of the cooking area. The identification marker M4 is arranged at the lower left corner of the cooking area. The identification markers M1 to M4 are painted in different patterns or colors to be identifiable from one another. Therefore, in the wearable image processing apparatus 1 that is not fixed to perform imaging, it is possible to determine, by detecting the identification markers M1 to M4 from a picked-up video, whether the video is a video of the cooking area (details are explained later).

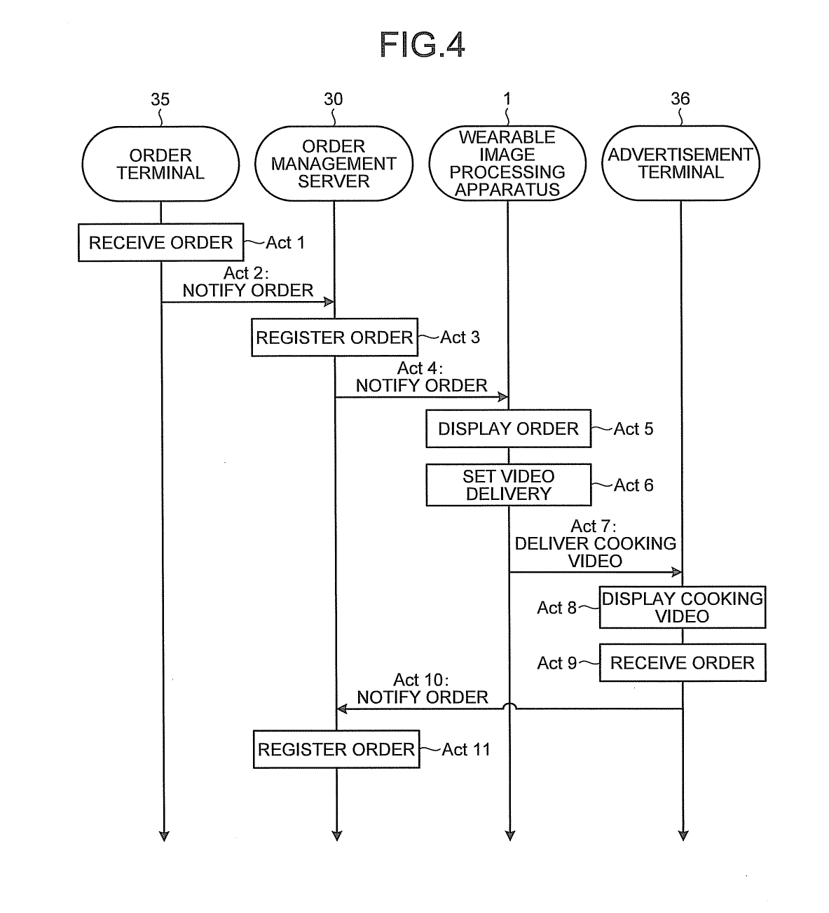

The operation of the order system according to this embodiment is explained below. FIG. 4 is a ladder chart of an example of the operation of the order system according to this embodiment.

As shown in FIG. 4, the order terminal 35 receives an order input of a customer table from which an order is received, the number of customers, order items, the numbers of the order items, and the like (Act 1). Subsequently, the order terminal 35 notifies the order management server 30 of the received order as order information (Act 2).

The order management server 30 registers the order information notified from the order terminal 35 (Act 3). Subsequently, the order management server 30 notifies the wearable image processing apparatus 1 of the registered order information and an order number of the order information (Act 4). The wearable image processing apparatus 1 displays the order information notified from the order management server 30 on the monitor display unit 17 (Act 5).

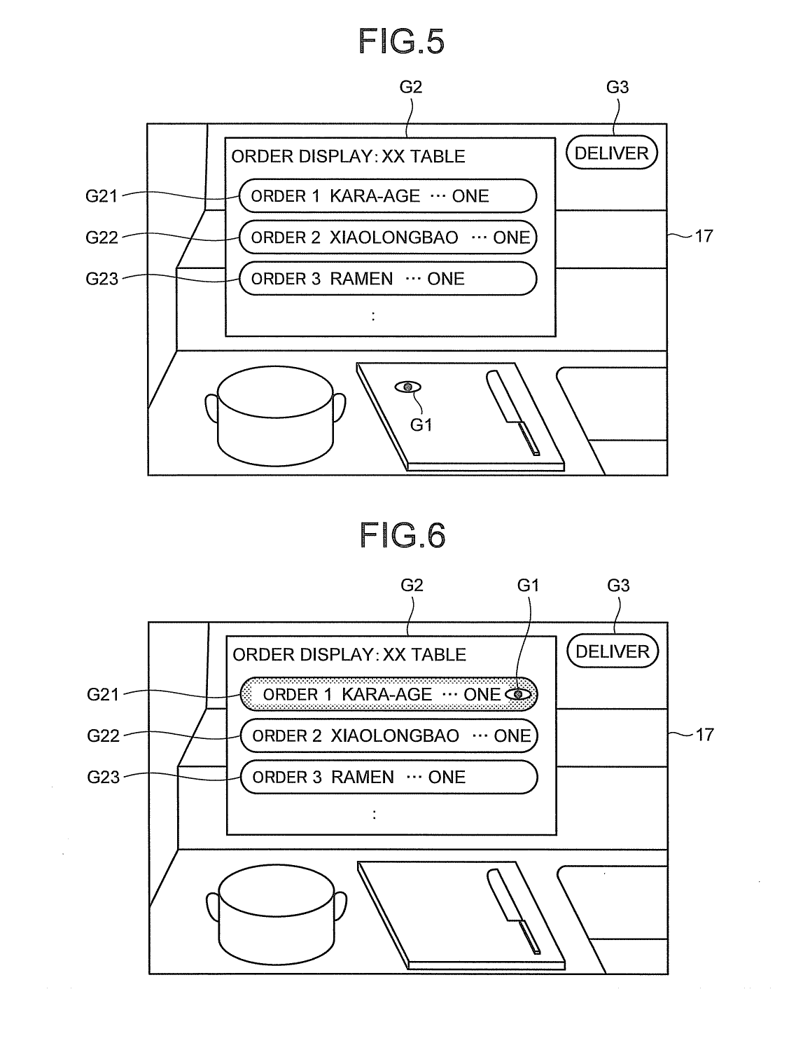

FIG. 5 is a diagram of a display example of the monitor display unit 17. More specifically, FIG. 5 is a diagram of a display example of the order information notified from the order management server 30. In FIG. 5, a line-of-sight marker G1 is a marker displayed on the monitor display unit 17 according to a detection result of the line of sight 2b. An order display window G2 is a display window for displaying the notified order information. A delivery icon G3 is an icon for receiving a delivery instruction for a video of the cooking area according to the line-of-sight operation.

As shown in FIG. 5, in Act 5, the order information notified from the order management server 30 is displayed in the order display window G2. Specifically, order icons G21 to G23 corresponding to order items included in the order information are displayed in the order display window G2. Consequently, the chef can start cooking of the order items included in the order information.

Subsequently, the wearable image processing apparatus 1 receives delivery setting for the video of the cooking area according to the sound operation or the video operation (Act 6). Specifically, in the case of the sound operation, the wearable image processing apparatus 1 performs the delivery setting for the video according to a sound command for instructing delivery of the video such as “deliver a video”. In the case of the line-of-sight operation, the wearable image processing apparatus 1 performs the delivery setting for the video when the wearable image processing apparatus 1 detects that the line-of-sight marker G1 overlaps the delivery icon G3 for a predetermined time.

In the delivery setting in Act 6, the wearable image processing apparatus 1 may set, according to the sound operation or the video operation, to which of the order items a video to be delivered corresponds. FIG. 6 is a diagram of a display example of the monitor display unit 17. More specifically, FIG. 6 is a diagram of an example of setting for order items. As shown in FIG. 6, in the case of the line-of-sight operation, the wearable image processing apparatus 1 performs the setting for order items by superimposing the line-of-sight marker G1 on an order icon. In the example shown in the figure, the wearable image processing apparatus 1 superimposes the line-of-sight marker G1 on the order icon G21 to set “kara-age” as an order item of a video to be delivered. Subsequently, the wearable image processing apparatus 1 delivers a video of “kara-age” set by the line-of-sight operation using the delivery icon G3. In the case of the sound operation, the wearable image processing apparatus 1 sets, according to a sound input of “order 1” or “kara-age”, “kara-age” corresponding to content of the sound as an order item of the video to delivered. Subsequently, the wearable image processing apparatus 1 delivers the video of “kara-age” according to a sound input such as “start delivery”.

Subsequently, the wearable image processing apparatus 1 delivers, together with information indicating the set order item, a video of the cooking area picked up by the digital camera 11 or the fixed camera 37 according to the delivery setting in Act 6, to the advertisement terminal 36 (Act 7). For example, in Act 6 and Act 7, after the display of the order information, the wearable image processing apparatus 1 receives selection of a cooking start item as the delivery setting according to the sound operation or the video operation, adds the order information of the cooking start item to the video of the cooking area, and delivers the order information. The order information of the cooking start item is added and delivered in order to show which food item is cooked in the video of the cooking area to be delivered. The advertisement terminal 36 displays, on the display, the video of the cooking area delivered from the wearable image processing apparatus 1 together with the delivered order information (Act 8). Therefore, in Act 8, the food item cooked in the video is displayed as a recommended lunch of the day or the like together with the video of the cooking area. Subsequently, the advertisement terminal 36 receives an order for the order item delivered together with the video (Act 9). The advertisement terminal 36 notifies, as order information, the order management server 30 of the order received in Act 9 (Act 10). The order management server 30 registers, as new order, the order information notified from the advertisement terminal 36 (Act 11).

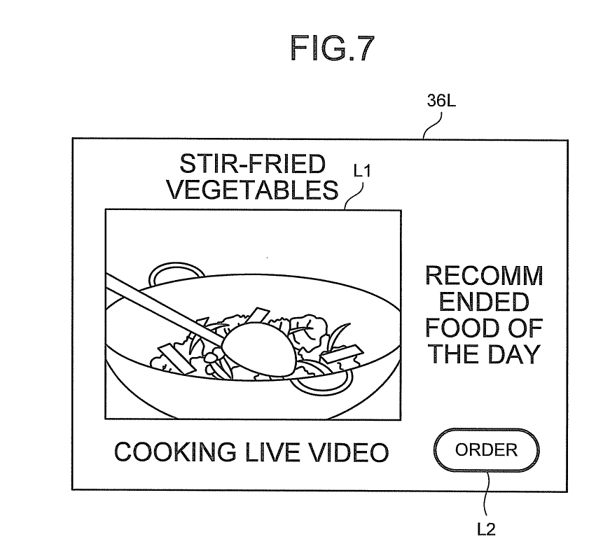

FIG. 7 is a diagram of a display example of a display 36L in the advertisement terminal 36. As shown in FIG. 7, in Act 8, a video of the cooking area is displayed in a cooking video display area L1 on the display 36L of the advertisement terminal 36. In this way, a video of cooking is displayed on the advertisement terminal 36 set on a customer table or the outdoors. This makes it possible to urge a customer to make a new order. On the display 36L of the advertisement terminal 36, an order icon L2 for receiving, in the operation input unit such as a touch panel, an order for the order item delivered together with the video of the cooking area. Therefore, according to Act 9 to Act 11, it is possible to receive anew an order concerning an order item being cooked.

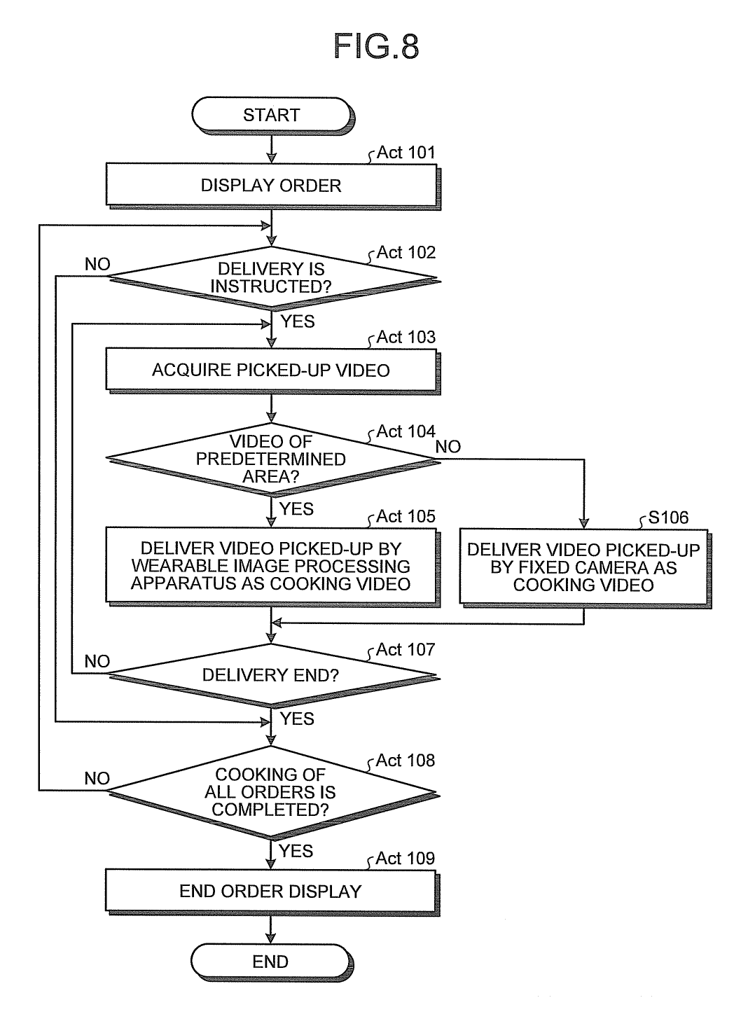

Details of processing performed by the wearable image processing apparatus 1 under the control by the control unit 121 are explained below with reference to FIG. 8. FIG. 8 is a flowchart for explaining the processing by the wearable image processing apparatus 1 according to this embodiment.

As shown in FIG. 8, when the processing is started, the control unit 121 displays, on the monitor display unit 17, an order item included in order information notified from the order management server 30 (Act 101). Subsequently, the control unit 121 determines, according to the sound operation or the line-of-sight operation, whether delivery of a video of the cooking area is instructed (Act 102). If the delivery is not instructed (No in Act 102), the control unit 121 advances the processing to Act 108.

When the delivery is instructed (Yes in Act 102), the control unit 121 acquires a video picked up by the digital camera 11 (Act 103). Subsequently, the control unit 121 determines, whether the acquired video is a video of a predetermined area, i.e., a video of the cooking area (Act 104). As explained above, the control unit 121 performs the determination in Act 104 by detecting the identification markers M1 to M4 from the acquired video. Specifically, if the identification marker M1 arranged at the upper left corner of the cooking area is detected on the upper left of the acquired video, the control unit 121 determines that the acquired video is a video of the cooking area. Similarly, in the acquired image, if the identification marker M2 is detected on the upper right, if the identification marker M3 is detected on the lower right, or if the identification marker M4 is detected at the left corner, the control unit 121 determines that the acquired video is a video of the cooking area. Conversely, in the acquired video, if the identification markers M1 to M4 are detected in positions other than those explained above or if the identification markers M1 to M4 are not detected, the control unit 121 determines that an image of the cooking area surrounded by the identification markers M1 to M4 is not picked up.

If the acquired video is a video of the cooking area (Yes in Act 104), the control unit 121 causes the wearable image processing apparatus 1 to deliver the video picked up by the digital camera 11 of the wearable image processing apparatus 1 to the advertisement terminal 36 as a video of the cooking area (Act 105). If the acquired video is not a video of the cooking area (No in Act 104), the control unit 121 causes the wearable image processing apparatus 1 to deliver the video picked up by the fixed camera 37 as a video of the cooking area (Act 106). Therefore, the wearable image processing apparatus 1 can deliver a lively cooking video close to the line of sight 2b of the wearer 2 to the advertisement terminal 36. Even when a video picked up by the wearable image processing apparatus 1 is a video of an area other than the cooking area because of behavior of the wearer 2, the wearable image processing apparatus 1 can always deliver a video of the cooking area to the advertisement terminal 36 by delivering a video of the fixed camera 37 to the advertisement terminal 36. For example, in Act 105 and Act 106, the wearable image processing apparatus 1 receives, according to the sound operation or the video operation, selection of a cooking start item as deliver setting after displaying the order information, adds order information of the cooking start item to the picked-up video of the cooking area, and delivers the order information. The order information of the cooking start item is added and delivered in order to show which food item is cooked in the video of the cooking area to be delivered. In Act 105, while the processing in Act 103 to Act 106 is repeated until an instruction for ending the delivery is received in Act 107 explained later, when the acquired video is a video of the cooking area for a predetermined time set in advance, the wearable image processing apparatus 1 may perform zoom-up of the acquired video. Specifically, the wearable image processing apparatus 1 performs electronic zoom for trimming a predetermined area from the acquired video and enlarging the predetermined area. When the zoom-up is performed in this way, the wearable image processing apparatus 1 can acquire a livelier video.

Subsequently, the control unit 121 determines, according to the sound operation or the line-of-sight operation, whether an instruction for ending the delivery is received (Act 107). If the instruction for ending the delivery is received (Yes in Act 107), the control unit 121 stops the delivery of a video to the advertisement terminal 36 and advances the processing to Act 108. If the instruction for ending the delivery is not received (No in Act 107), the control unit 121 advances the processing to Act 103 and continues the delivery of a video to the advertisement terminal 36. For example, in the case of the sound operation, the control unit 121 ends the delivery of a video according to a sound command for ending the delivery of a video such as “end delivery”. In the case of the line-of-sight operation, the control unit 121 ends the delivery of a video when the control unit 121 detects that the line-of-sight marker G1 overlaps, for a predetermined time, an icon image similar to the delivery icon G3 as an icon image for ending the delivery of a video (not specifically shown).

In Act 108, the control unit 121 determines, according to whether operation indicating completion of cooking is performed by the sound operation or the line-of-sight operation, whether cooking of all order items displayed on the monitor display unit 17 is completed (Act 108). If the cooking is not completed (No in Act 108), the control unit 121 returns the processing to Act 102. If the cooking is completed (Yes in Act 108), the control unit 121 ends the display of the order items on the monitor display unit 17 (Act 109) and ends the processing. For example, in the case of the sound operation, the control unit 121 ends the processing according to a sound command indicating completion of cooking such as “complete cooking”. In the case of the line-of-sight operation, the control unit 121 ends the processing when the control unit 121 detects that the line-of-sight marker G1 overlaps, for a predetermined time, an icon image similar to the delivery icon G3 as an icon image for indicating completion of cooking (not specifically shown). Both of the completion of cooking and the completion of delivery may be performed according to one instruction by the sound operation or the line-of-sight operation.

In this embodiment, the wearable image processing apparatus 1 used while being mounted on the wearer 2 is explained as the example. However, the display and operation configuration in the wearable image processing apparatus 1 may be a stationary type. Specifically, the wearable image processing apparatus 1 may have, on the outside, a display such as a LCD (Liquid Crystal Display) and an operation input unit such as a touch panel or operation keys set in predetermined positions. The operation input by the user is not limited to the sound operation or the line-of-sight operation and may be performed by the touch panel or the operation keys. A host apparatus such as the order management server 30 may display monitor display of order information or the like on a display set in a predetermined position. In this case, the wearable image processing apparatus 1 does not include the monitor display unit 17 and performs the operation input as sound input.

Computer programs executed by the CPUs of the control unit 121 and the order management server 30 may be provided while being incorporated in the ROM or the like in advance. The computer programs may be provided while being recorded in a computer-readable recording medium such as a CD-ROM, a flexible disk (FD), a CD-R, or a DVD as a file of an installable or executable format.

The computer programs may be stored on a computer connected to a network such as the Internet and provided while being downloaded through the network. The computer programs may be provided or distributed through the network such as the Internet.

The present invention is not limited to the embodiment per se. At an implementation stage, the elements can be modified and embodied without departing from the spirit of the present invention. Various inventions can be formed by appropriate combination of the plural elements disclosed in the embodiment. For example, several elements may be deleted from all the elements described in the embodiment. The elements described in different embodiments may be combined as appropriate.

While certain embodiments have been described, these embodiments have been presented by way of example only, and are not intended to limit the scope of the inventions. Indeed, the novel terminals and methods described herein may be embodied in a variety of other forms; furthermore, various omissions, substitutions and changes in the form of the terminals and methods described herein may be made without departing from the spirit of the inventions. The accompanying claims and their equivalents are intended to cover such forms or modifications as would fall within the scope and spirit of the inventions.

What is claimed is:

1. An image processing apparatus comprising:
an imaging unit configured to pick up a video of a cooking scene;
a selecting unit configured to select, out of order items received from a customer, an order item to be delivered;
a receiving unit configured to receive, from a user, a delivery instruction for a video of a cooking scene related to the selected order item; and
a delivering unit configured to deliver the picked-up video of the cooking scene according to the received delivery instruction.

2. The apparatus according to claim 1, further comprising:
a sound collecting unit configured to collect sound of the user; and
a sound recognizing unit configured to recognize a sound command from the user on the basis of the collected sound, wherein
the receiving unit receives the delivery instruction corresponding to the recognized sound command.

3. The apparatus according to claim 1, further comprising a line-of-sight detecting unit configured to detect a line-of-sight position of the user, wherein
the receiving unit receives the delivery instruction corresponding to the detected line-of-sight position.

4. The apparatus according to claim 1, wherein the delivering unit adds the selected order item to the picked-up video of the cooking scene and delivers the selected order item.

5. The apparatus according to claim 1, wherein the imaging unit zooms up and picks up an image when time set in advance elapses.

6. A wearable image processing apparatus comprising:
an imaging unit configured to pick up a video of a cooking scene;
a head mount display including a monitor display unit configured to display order items included in order information received from a customer;
a selecting unit configured to select, out of the displayed order items, an order item to be delivered;
a receiving unit configured to receive, from a wearer of the head mount display, a delivery instruction for a video of a cooking scene related to the selected order item; and
a delivering unit configured to deliver the picked-up video of the cooking scene according to the received delivery instruction.

7. The apparatus according to claim 6, further comprising:
a sound collecting unit configured to collect sound of the user; and
a sound recognizing unit configured to recognize a sound command from the user on the basis of the collected sound, wherein
the receiving unit receives the delivery instruction corresponding to the recognized sound command.

8. The apparatus according to claim 6, further comprising a line-of-sight detecting unit configured to detect a line-of-sight position of the user, wherein
the receiving unit receives the delivery instruction corresponding to the detected line-of-sight position.

9. The apparatus according to claim 6, wherein the delivering unit adds the selected order item to the picked-up video of the cooking scene and delivers the video.

10. The apparatus according to claim 6, wherein the imaging unit zooms up and picks up an image when time set in advance elapses.

11. A method of controlling an image processing apparatus including an imaging unit configured to pick up a video of a cooking scene, the method comprising:
selecting, out of order items received from a customer, an order item to be delivered;
receiving, from a user, a delivery instruction for a video of a cooking scene related to the selected order item; and
delivering the picked-up video of the cooking scene according to the delivery instruction.
